(19) United States
(12) Patent Application Publication
(10) Pub. No.: US 2009/0226179 A1
(43) Pub. Date: Sep. 10, 2009

(54) COMPOSITE INPUT DEVICE AND INPUT METHOD THEREOF

(75) Inventor: Wang-Hung YEH, Taoyuan City (TW)

Correspondence Address: Workman Nydegger;1000 Eagle Gate Tower, 60 East South Temple, Salt Lake City, UT, 84111, US

(73) Assignee: MOBINNOVA CORP., Taoyuan City (TW)

(21) Appl. No.: 12/142,959

(22) Filed: Jun. 20, 2008

(30) Foreign Application Priority Data
Mar. 5, 2008 (TW) 097107738

(51) Int. Cl. H04B 10/00

(52) U.S. Cl. 398/135

(57) ABSTRACT

A composite input device and an input method thereof are described. A plurality of pressing members outputs a first signal in response to a press. The first signal is used for actuating a corresponding first function of each of the pressing members. A plurality of optical transceivers is respectively disposed in the pressing members, and each of the optical transceivers transmits an optical signal to pass through each of the pressing members and outputs a second signal on receiving the reflected optical signal. The second signal is used for actuating a corresponding second function of each of the pressing members.

### CROSS-REFERENCE TO RELATED APPLICATIONS

This non-provisional application claims priority under 35 U.S.C. § 119(a) on Patent Application No(s). 097107738 filed in Taiwan, R.O.C. on Mar. 5, 2008 the entire contents of which are hereby incorporated by reference.

### BACKGROUND OF THE INVENTION

1. Field of Invention

The present invention relates to a key and an input method thereof, and more particularly to a composite input device with a light sensitive input and a mechanical input and an input method thereof.

2. Related Art

People now can use a mobile communication to contact each other at any time anywhere instead of searching for a public telephone or borrowing an indoor telephone to make a phone call in the past. Therefore, it is very common in today's society that almost everybody has a mobile phone. In order to improve the plurality capability of the mobile communication device, functions such as music playback, game, photograph, internet browsing are added to enable a user to entertain besides communication.

As many functions are added to the mobile communication device, the mobile communication device is generally built with a five-direction key for selecting the desired function and contacts list and meanwhile serving as a control key for entertainment functions. However, under the trend that the mobile communication device is becoming lighter, thinner, shorter, and smaller, as the five-direction key occupies certain space on the mobile communication device, the space for building other elements such as the numeric keys and the display screen is reduced and the cost cannot be lowered.

### SUMMARY OF THE INVENTION

Accordingly, the present invention is directed to a composite input device and an input method thereof for replacing the five-direction key, so as to prevent the five-direction key from occupying the space for building other elements such as the numeric keys and the display screen is reduced and the cost cannot be lowered on the mobile communication device.

A composite input device including a plurality of pressing members and a plurality of optical transceivers is provided. The plurality of pressing members outputs a first signal in response to a press. The first signal is used for actuating a corresponding first function of each of the pressing members. The plurality of optical transceivers is respectively disposed in the pressing members, and each of the optical transceivers transmits an optical signal to pass through each of the pressing members and outputs a second signal on receiving the reflected optical signal. The second signal is used for actuating a corresponding second function of each of the pressing members.

An input method of a composite input device is also provided. The method includes the following steps: outputting a first signal for actuating a corresponding first function of one of a plurality of pressing members that outputs the first signal in response to a press; transmitting a plurality of optical signals, each corresponding to one of the plurality of pressing members and passing through the corresponding pressing member; and outputting a second signal for actuating a corresponding second function of the pressing member on receiving the reflected optical signal.

The input method of a composite input device provided by the present invention further includes: transmitting a third signal if a plurality of reflected optical signals is continuously received within a second time interval, in which the third signal is used for actuating a corresponding third function of the continuously received reflected optical signals; and transmitting a fourth signal if the reflected optical signal from the same pressing member is continuously received for more than a third time interval, in which the fourth signal is used for actuating a corresponding fourth function of the continuously received reflected optical signal.

In the composite input device and the input method thereof provided by the present invention, a plurality of optical transceivers is respectively disposed in a plurality of pressing members, so that a corresponding second function (for example, a five-direction key function) of each of the pressing members is actuated when each of the optical transceivers receives a reflected optical signal. Thereby, the five-direction key used to be built on a mobile communication device can be replaced, so as to increase the space on the mobile communication device and also save the cost of fabricating the five-direction key.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a composite input device according to a first embodiment of the present invention;

FIG. 2 is a schematic cross-sectional view of the composite input device of the first embodiment;

FIG. 3 is a schematic view of the actuation of a third function of the composite input device according to the present invention;

FIG. 4 is a schematic view of a composite input device according to a second embodiment of the present invention;

FIG. 5 is a schematic cross-sectional view of the composite input device of the second embodiment; and

FIG. 6 is a flow chart of an input method of a composite input device according to the present invention.

### DETAILED DESCRIPTION OF THE INVENTION

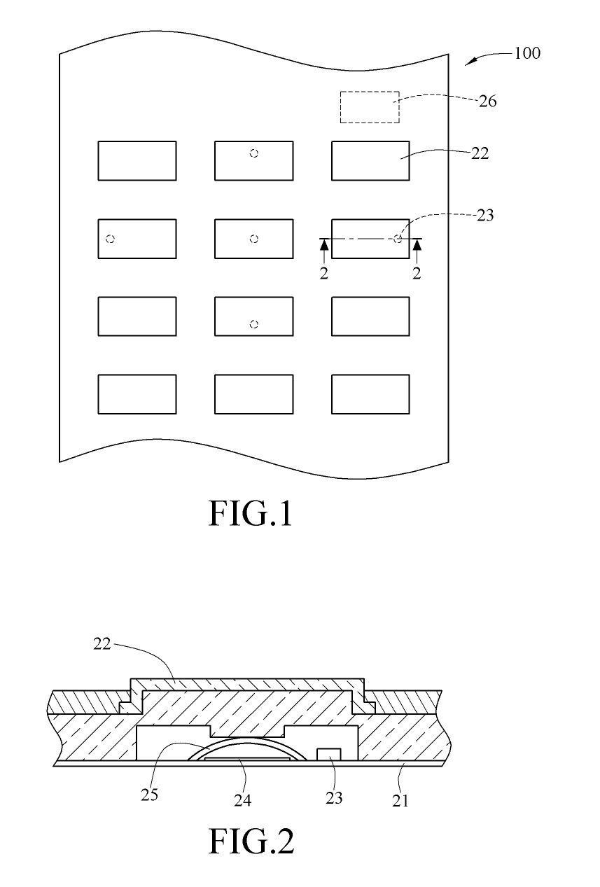

Referring to FIGS. 1 and 2, FIG. 1 is a schematic view of a composite input device according to a first embodiment of the present invention, and FIG. 2 is a schematic cross-sectional view of the composite input device of the first embodiment. The composite input device 100 according to the first embodiment of the present invention includes a circuit board 21, a plurality of pressing members 22, and a plurality of optical transceivers 23.

A plurality of electrical contacts 24 is configured on the circuit board 21, and each of the electrical contacts 24 is electrically connected to a metal wire on the circuit board. Meanwhile, a hemispherical mask 25 is formed on each of the electrical contacts 24 and covering the same, such that when the hemispherical mask 25 is pressed to touch the electrical contact 24, the electrical contact 24 outputs a signal in response to the press. The hemispherical mask 25 is made of a metal or other materials like plastic.

When pressed, the pressing member 22 will press the hemispherical mask 25 to touch the electrical contact 24, and the electrical contact 24 will output a first signal in response to the press. The first signal is used for actuating a corresponding first function of each of the pressing members 22. The first function may be an activation function, a close function, a digital function, or a symbol function. The pressing member 22 is made of a light transparent material or only the part corresponding to the optical transceiver 23 is made of a light transparent material.

The plurality of optical transceivers 23 is respectively disposed in the pressing members 22. Each of the optical transceivers 23 is used for transmitting an optical signal to pass through each of the pressing members 22 made of a light transparent material. When the optical signal is blocked and reflected back into each of the pressing members 22, the optical transceiver 23 outputs a second signal on receiving the reflected optical signal. The second signal is used for actuating a corresponding second function of each of the pressing members 22. The second function is a direction key function for actuating operations such as transforming a menu or option. The second function may also be a network connection function or a video function. The optical transceiver 23 includes an optical receiving unit and an optical transmitting unit. The optical transmitting unit may be a laser diode or a light-emitting diode for transmitting laser or infrared optical signals. The optical receiving unit is a photodiode for receiving the optical signals to generate a current.

In the first embodiment, the composite input device further includes a processor 26. The processor 26 is electrically connected to the plurality of optical transceivers 23. When each of the pressing members 22 with the optical transceivers 23 respectively disposed therein is to be pressed to actuate the corresponding first function of each of the pressing members 22, the optical signal may be shielded and reflected first. As a result, the optical transceiver 23 may actuate the corresponding second function of each of the pressing members 22 on receiving the reflected optical signal, and thus an undesired function is performed in advance. Therefore, the processor 26 is used here as a delayer for delaying the actuation of the second function after receiving the second signal, so as to avoid the above circumstance. In particular, the processor 26 actuates the first function on receiving the first signal within a time interval after receiving the second signal, and otherwise actuates the second function if not receiving the first signal within a time interval.

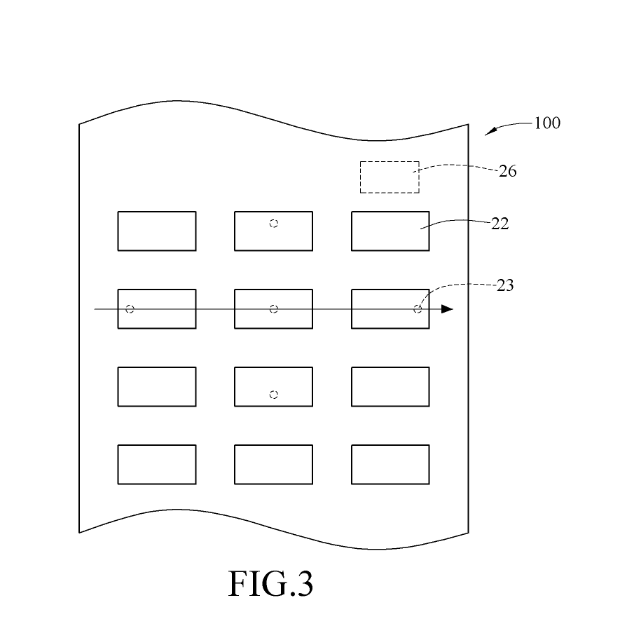

Referring to FIG. 3, a schematic view of the actuation of a third function of the composite input device according to the present invention is shown. When the optical signals output from the plurality of optical transceivers 23 are continuously shielded and reflected, if the processor 26 keeps on receiving the second signals transmitted by the optical transceivers 23 in a second time interval, a third signal is sent out. The third signal is used for actuating a corresponding third function of the continuously received second signals transmitted by the plurality of optical transceivers 23. The third function may be a sliding function or a scrolling function.

Meanwhile, if the processor 26 continuously receives the second signal transmitted by one of the plurality of optical transceivers 23 in a third time interval, a fourth signal is sent out. The fourth signal is used for actuating a corresponding fourth function of the continuously received second signal transmitted by one of the plurality of optical transceivers 23. The fourth function may be a video function or a network connection function.

Therefore, in the first embodiment, after the pressing member 22 is pressed, a corresponding first function of the pressing member 22 is actuated. In addition, an optical transceiver 23 is further disposed in the pressing member 22, so that a corresponding second function (for example, a five-direction key function) of the pressing member 22 is actuated when the optical transceiver 23 receives a reflected optical signal. Thereby, the five-direction key used to be built on a mobile communication device can be replaced, so as to increase the space on the mobile communication device and also save the cost of fabricating the five-direction key.

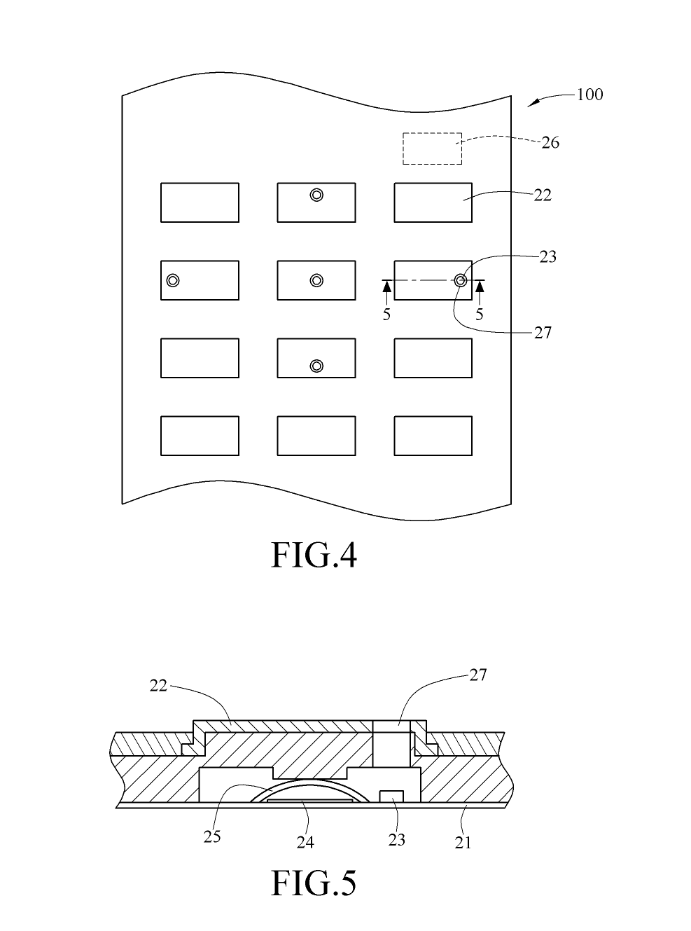

Referring to FIGS. 4 and 5, FIG. 4 is a schematic view of a composite input device according to a second embodiment of the present invention, and FIG. 5 is a schematic cross-sectional view of the composite input device of the second embodiment. The second embodiment of the present invention is identical to the first embodiment in structure but with the following differences. Each of the pressing members 22 in the second embodiment of the present invention is made of an opaque material, and each provided with a penetration hole 27. Thereby, the optical signal transmitted by each of the optical transceivers 23 passes through each of the pressing members 22 via the penetration hole 27, and each of the optical transceivers 23 receives the reflected optical signal via the penetration hole 27 so as to actuate the second function.

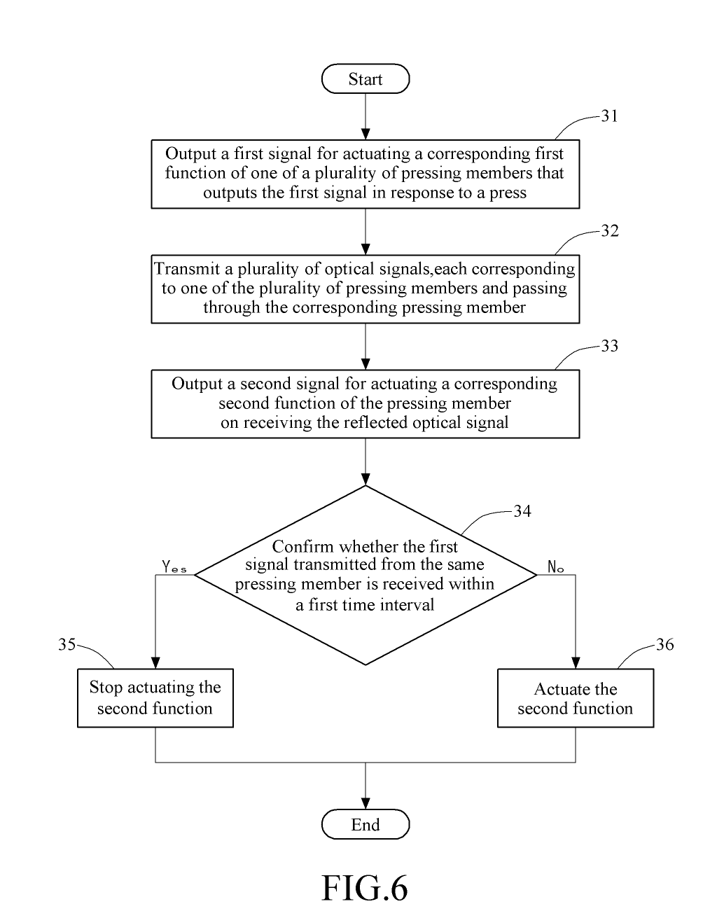

Referring to FIG. 6, a flow chart of an input method of a composite input device according to the present invention is shown. A first signal for actuating a corresponding first function of one of the plurality of pressing members is output in response to a press (Step 31).

A plurality of optical signals, each corresponding to one of the plurality of pressing members and passing through the corresponding pressing member, is sent out (Step 32).

A second signal for actuating a corresponding second function of the pressing member is output when the reflected optical signal is received (Step 33). The second function refers to a direction key function or other functions.

The actuation of the second function is delayed after the second signal is received, and it is confirmed whether the first signal transmitted from the same pressing member is received within a first time interval (Step 34). The first time interval is three seconds or other time.

The actuation of the second function is stopped if the first signal transmitted from the same pressing member is received within the first time interval (Step 35).

The second function is actuated if the first signal transmitted from the same pressing member is not received within the first time interval (Step 36).

In the input method of a composite input device of the present invention, the corresponding first function of each of the pressing members is actuated in response to the press of each of the pressing members. The optical transceiver disposed in each of the pressing members transmits the optical signal, and actuates the corresponding second function of each of the pressing members on receiving the reflected optical signal. In order to prevent the second signal from being sent out by mistake as the optical signal is shielded and reflected during the press of each of the pressing members, the actuation of the corresponding second function of each of the pressing members is delayed first after the second signal is received. If the first signal from the same pressing member is received within the first time interval, the corresponding first function of each of the pressing members is actuated, and if the first signal from the same pressing member is not received within the first time interval, the corresponding second function of each of the pressing members is actuated.

The input method of a composite input device of the present invention further includes a step of transmitting a third signal if a plurality of reflected optical signals is continuously received within the second time interval. The third signal is used for actuating a corresponding third function of the continuously received reflected optical signals. The third function refers to a sliding function or a scrolling function.

The input method of a composite input device of the present invention further includes a step of transmitting a fourth signal if the reflected optical signal from the same pressing member is continuously received for more than a third time interval. The fourth signal is used for actuating a corresponding fourth function of the continuously received reflected optical signal. The fourth function may be a video function or a network connection function.

What is claimed is:

1. A composite input device, comprising:
a plurality of pressing members, each for outputting a first signal in response to a press, wherein the first signal actuates a corresponding first function of each of the pressing members; and
a plurality of optical transceivers, respectively disposed in the pressing members, and each of the optical transceivers transmits an optical signal to pass through each of the pressing members and outputs a second signal on receiving the reflected optical signal, wherein the second signal actuates a corresponding second function of each of the pressing members.

2. The composite input device as claimed in claim 1, wherein each of the pressing members is formed with a penetration hole, such that the optical signal passes through each of the pressing members via the penetration hole.

3. The composite input device as claimed in claim 1, wherein each of the pressing members is made of a light transparent material for the optical signal to pass through.

4. The composite input device as claimed in claim 1, wherein the optical transceiver comprises an optical transmitting unit for transmitting the optical signal to pass through each of the pressing members and an optical receiving unit for receiving the reflected optical signal so as to output the second signal.

5. The composite input device as claimed in claim 1, further comprising a processor electrically connected to the optical transceivers, for delaying the actuation of the second function after the second signal is received and actuating the first function if the first signal is received within a time interval.

6. The composite input device as claimed in claim 1, further comprising a processor, for delaying the actuation of the second function after the second signal is received and actuating the second function if the first signal is not received within a time interval.

7. An input method of a composite input device, comprising:
outputting a first signal for actuating a corresponding first function of one of a plurality of pressing members that outputs the first signal in response to a press;
transmitting a plurality of optical signals, each corresponding to one of the plurality of pressing members and passing through the corresponding pressing member; and
outputting a second signal for actuating a corresponding second function of the pressing member on receiving the reflected optical signal.

8. The input method of a composite input device as claimed in claim 7, further comprising:
stopping actuating the second function if the first signal transmitted from the same pressing member is received within a first time interval after the second signal is received; and
actuating the second function if the first signal transmitted from the same pressing member is not received within a first time interval after the second signal is received.

9. The input method of a composite input device as claimed in claim 7, wherein the step of actuating the corresponding second function of the pressing member is actuating a corresponding direction key function of the pressing member.

10. The input method of a composite input device as claimed in claim 7, further comprising a step of transmitting a third signal if a plurality of reflected optical signals is continuously received within a second time interval, wherein the third signal is used for actuating a corresponding third function of the continuously received reflected optical signals.

11. The input method of a composite input device as claimed in claim 10, wherein the step of actuating the corresponding third function of the continuously received plurality of reflected optical signals is actuating a corresponding sliding function or scrolling function of the continuously received reflected optical signals.

12. The input method of a composite input device as claimed in claim 7, further comprising a step of transmitting a fourth signal if the reflected optical signal from the same pressing member is continuously received for more than a third time interval, wherein the fourth signal is used for actuating a corresponding fourth function of the continuously received reflected optical signal.
